(19) United States
(12) Patent Application Publication
(10) Pub. No.: US 2017/0109723 A1
(43) Pub. Date: Apr. 20, 2017

(54) PARTY MANAGEMENT SERVICE METHOD AND DEVICE THEREFOR

(71) Applicant: SK PLANET CO., LTD., Seongnam-si Gyeonggi-do (KR)

(72) Inventor: Jongwon WOO, Incheon (KR)

(21) Appl. No.: 15/393,227

(22) Filed: Dec. 28, 2016

Related U.S. Application Data
(63) Continuation of application No. PCT/KR2015/013456, filed on Dec. 9, 2015.

(30) Foreign Application Priority Data
Jun. 11, 2015 (KR) 10-2015-0082509

(51) Int. Cl. G06Q 20/32; G06Q 20/10; H04W 4/02; H04B 17/318; H04W 4/00

(52) U.S. Cl. CPC G06Q 20/327; H04B 17/318; H04W 4/008; H04W 4/027; G06Q 20/325; G06Q 20/102

(57) ABSTRACT

The present invention relates to a party management service method and a device therefor, and relates to a party management service method and a device therefor, which: determine whether users enter a shop by using short-range wireless communication; generate user groups by grouping shop entries according to each time slot; and determine and manage a party according to payment information of any one of user groups and exiting information of a user group to which a user, who has paid, belongs, such that shop usage details of a user who did not pay when using the shop can be confirmed, thereby providing personalized customized content.

### CROSS-REFERENCE TO RELATED APPLICATION

This application claims priority to and the benefit of Korean Patent Application No. 10-2015-0082509 filed in the Korean Intellectual Property Office on Jun. 11, 2015 the entire contents of which are incorporated herein by reference.

### TECHNICAL FIELD

The present disclosure relates to a party management service method using short-range wireless communication and a device therefor, and more particularly, to a party management service method that uses a short-range wireless communication signal to determine whether a user has entered or exited a shop and generates a user group by entrance time slot to determine people who exited together at an exit time point of a payer as being in the same party as the payer, and a device therefore.

### BACKGROUND

Content given in this section merely provides background information on embodiments of the present disclosure and does not constitute a related art.

With the development of mobile communication networks and the advance in terminal specifications, mobile communication terminals have become a necessity for modern people and have evolved into total entertainment equipment beyond the category of simple communication devices or information provision devices.

Particularly, a payment service using a smartphone is being frequently used nowadays. When purchasing a product from a member shop, a membership card that enables accumulating points or getting discounts is provided through a mobile service, and a credit card function is also provided through a mobile application. Here, a user has to own a mobile card and a credit card which are previously issued and may proceed with a payment by tagging a previously issued mobile card at a near field communication (NFC) reader connected to a point of sales (POS) terminal or directly presenting a previously issued credit card in a member shop that has a POS system to which NFC tagging is connected.

In this case, the POS terminal acquires card information read by the NFC reader or card information read by a card reader, goes through a value added network (VAN) company, and receives payment authorization from a card company.

In such an existing system, a user's propensity to consume is analyzed using only limited information such as information on the user's credit card usage. Thus, there is a problem in that the propensity to consume of a user who does not use a credit card or visits a shop but does not make a payment cannot be identified.

That is, when multiple users visit a place, such as a general restaurant, together, the propensity to consume of a payer who makes a payment can be identified because a user's propensity to consume has to be analyzed using only information on the payer who makes a payment. However, there is a problem in that a shop visit record of a person who has used a service, such as having a meal together with the payer, but has not made payment is excluded from targets of analysis.

### SUMMARY

The present disclosure has been proposed to solve the above inconvenience and is directed to a party management service method for determining whether a user has entered or exited a shop by using signal intensity information from a user terminal that received a short-range wireless communication signal, grouping users who entered the shop by time slot, and determining that a user who exited the shop together with a user who made a payment is in the same party as the user who made the payment, and a device therefor.

Further, the present disclosure is directed to a party management service method using short-range wireless communication in which a party of a user who made a payment is extracted using the short-range wireless communication so that usage history of a user who did not make the payment may also be analyzed and personally customized content may be provided, and a device therefor.

### TECHNICAL SOLUTION

To achieve the objectives described above, a service device for party management in a party management service according to an embodiment of the present disclosure includes an entry/exit management module configured to receive signal intensity information on a short-range wireless communication signal received by a user terminal from the user terminal and determine whether a user has entered or exited a shop based on the signal intensity information, a payment information collection module configured to receive payment information of the user terminal from a payment device, and a party management module configured to generate user groups by time slot for multiple users determined as having entered the shop by the entry/exit management module and, when a payment is made by any one of the users who have entered the shop, determine that users, that are confirmed as having exited the shop within a first time range based on a time point at which the user who made the payment is confirmed as having exited the shop, among users in a user group to which the user who made the payment belongs are in the same party as the user who made the payment.

Also, the service device according to an embodiment of the present disclosure may further include a storage module configured to store a result of the determination by the party management module.

Here, the entry/exit management module of the service device according to an embodiment of the present disclosure may determine that the user has entered the shop when intensity of the short-range wireless communication signal from the user terminal has increased to a critical value or higher and may determine that the user has exited the shop when the intensity of the short-range wireless communication signal has decreased to lower than the critical value.

Also, the party management module of the service device according to an embodiment of the present disclosure may, before determining the same party, acquire movement information from a plurality of user terminals included in the user group to which the user who made the payment belongs, select users corresponding to user terminals from which movement of certain degree or more is detected for a predetermined amount of time as party) candidates, and confirm whether the users included in the party candidates have exited the store.

Also, the party management module of the service device according to an embodiment of the present disclosure may assign a weight to the users in the user group to which the user who made the payment belongs in consideration of a previous result of a determination stored in a storage module, and may perform the determination according to the weight.

Also, the party management module of the service device according to an embodiment of the present disclosure may assign a weight to a user who exited the shop at a time point that deviates from the first time range among the users in the user group to which the user who made the payment belongs in consideration of a previous result of a determination stored in a storage module, and may determine a party according to the weight.

Also, the party management module of the service device according to an embodiment of the present disclosure may remove a user who is determined as being in the same party from the generated user group.

To achieve the objectives described above, a party management service method in a party management service according to an embodiment of the present disclosure includes receiving, by a service device, intensity information on a short-range wireless communication signal from a user terminal; determining, by the service device, whether a user has entered or exited a shop based on the received signal intensity information, generating, by the service device, user groups by time slot for multiple users determined as having entered the shop, receiving, by the service device, payment information of the user terminal from a payment device, and, when a payment is made by any one of the users who entered the shop, determining, by the service device, that users, that are confirmed as having exited the shop within a first time range based on a time point at which the user who made the payment is confirmed as having exited the shop, among users in a user group to which the user who made the payment belongs are in the same party as the user who made the payment.

Here, the party management service method according to an embodiment of the present disclosure may further include, after the determining the same party, storing a result of the determination by the party management module.

Also, the determining of whether the user has entered or exited the shop of the party management service method according to an embodiment of the present disclosure may include determining that the user has entered the shop when intensity of the short-range wireless communication signal from the user terminal has increased to a critical value or higher and determining that the user has exited the shop when the intensity of the short-range wireless communication signal has decreased to lower than the critical value.

Also, the party management service method according to an embodiment of the present disclosure may include, before the determining the same party, acquiring movement information from a plurality of user terminals included in the user group to which the user who made the payment belongs, selecting users corresponding to user terminals from which movement of certain degree or more is detected for a predetermined amount of time as party candidates, and confirming whether the users included in the party candidates have exited the store.

Also, the determining the same party of the party management service method according to an embodiment of the present disclosure may include assigning a weight to the users in the user group to which the user who made the payment belongs in consideration of a previous result of a determination stored in a storage module, and performing the determination according to the weight.

Also, the determining the same party of the party management service method according to an embodiment of the present disclosure may include assigning a weight to a user who exited the shop at a time point that deviates from the first time range among the users in the user group to which the user who made the payment belongs in consideration of a previous result of a determination stored in a storage module, and determining the same party according to the weight.

Also, the party management service method according to an embodiment of the present disclosure may further include, after the determining the same party, removing a user who is determined as being in the same party from the generated user group.

According to the present disclosure, because a user who enters or exits a shop and people in the same party as the user can be identified using a short-range wireless communication signal, a person who has made a payment using a credit card and the like as well as a person who has visited the shop but not made a payment can be identified, and a shop visit record of a person who has not made a payment can be identified.

Also, according to the present disclosure, shop visit records of a person who has made a payment and a person who has not made a payment can be identified, and personalized content can be provided based on the identified shop visit records.

Thus, existing problems in that a shop visit record of only a person who has made a payment is identified, a shop visit record of a person who has visited the shop but not made payment is difficult to identify, and personalized content and various types of information are unable to be provided can be solved by the present disclosure.

Further, various advantageous effects other than the advantageous effects described above may be explicitly or implicitly disclosed in the detailed description below according to an embodiment of the present disclosure.

### BRIEF DESCRIPTION OF THE DRAWINGS

FIG. 1A is a view illustrating a party management service system using an access point (AP) according to an embodiment of the present disclosure.

FIG. 1B is a view illustrating a party management service system using a beacon according to another embodiment of the present disclosure.

FIG. 2 is a view illustrating a configuration of a user terminal according to an embodiment of the present disclosure.

FIG. 3 is a view illustrating a configuration of a service device according to an embodiment of the present disclosure.

FIG. 4 is a flowchart for describing a method of determining that a user has entered a shop by the service device according to an embodiment of the present disclosure.

FIG. 5 is a flowchart for describing a method of determining that a user has exited a shop by the service device according to an embodiment of the present disclosure.

FIG. 6 is a flowchart for describing a method of determining the same party by the service device according to an embodiment of the present disclosure.

FIG. 7 is a view for describing a method of determining whether a user has entered or exited a shop using signal intensity information according to an embodiment of the present disclosure.

FIG. 8 is a view for describing a method of determining the same party according to an embodiment of the present disclosure.

FIG. 9 is a view illustrating party information managed by a storage module according to an embodiment of the present disclosure.

FIG. 10 is a view illustrating an operating environment of a device for providing a party management service according to an embodiment of the present disclosure.

### DETAILED DESCRIPTION

Hereinafter, the present disclosure will be described in more detail with reference to particular embodiments of the present disclosure illustrated in the accompanying drawings to further clarify features and advantages of the technical solution of the present disclosure.

However, detailed descriptions of known functions or configurations that may obscure the gist of the present disclosure will be omitted in the description below and the accompanying drawings.

Also, it should be noted that like elements are represented with like reference numerals as possible throughout the drawings.

Terms or words used in the description below and the drawings are not to be construed as being limited to having general or dictionary meanings but should be construed as having meanings and concepts consistent with the technical spirit of the present disclosure based on a principle that the inventor may properly define terms as having concepts for describing his or her invention in the best way.

Consequently, because embodiments described herein and configurations illustrated in the drawings are merely the most preferred embodiments of the present disclosure and do not represent all of the technical spirit of the present disclosure, it should be understood that various equivalents and modified embodiments that may substitute for the most preferred embodiments may be present at the time of applying this application.

Also, terms including ordinals such as first and second may be used to describe various elements. The terms are only used for the purpose of distinguishing one element from another element and are not used to limit the elements. For example, a second element may be referred to as a first element while not departing from the scope of the present disclosure, and likewise, a first element may also be referred to as a second element.

Furthermore, when it a certain element is described as being “connected” or “linked” to another element, the description means that, although the certain element may be directly connected or linked to the other element, the certain element may be connected or linked to the other element logically or physically.

In other words, it should be understood that, although an element may be directly connected or linked to another element, yet another element may exist therebetween, and the element may be indirectly connected or linked to the other element.

Also, terms used herein are merely used to describe particular embodiments and are not intended to limit the present disclosure.

A singular expression includes a plural expression unless the context clearly indicates otherwise.

Also, terms such as “include” or “have” used herein should be understood as designating that features, number, steps, operations, elements, parts, or combinations thereof exist and not as precluding the existence of or the possibility of adding one or more other features, numbers, steps, operations, elements, parts, or combinations thereof in advance.

Furthermore, embodiments within the scope of the present disclosure include a computer readable medium that has or delivers a computer executable command or a data structure stored in a computer readable medium.

The computer readable medium may be any usable medium that may be accessed by a computer system for a universal or special purpose.

For example, the computer readable medium may include a random access memory (RAM), a read only memory (ROM), an erasable programmable ROM (EPROM), a compact disc (CD)-ROM or other optical disc storage devices, a magnetic disk storage device or other magnetic storage devices, or a physical storage medium including any other media that may be used to store or deliver a computer executable command, a computer readable command, or a predetermined program coding means in the form of a data structure or may be accessed by a computer system for a universal or special purpose, but the computer readable medium is not limited thereto.

A computer readable command includes, for example, a command and data that enables a universal computer system or a special purpose computer system to perform a specific function or a group of functions.

A computer executable command may be, for example, an assembly language or even a binary or intermediate format command such as a source code.

Furthermore, the present disclosure may be practiced in a network computing environment having various types of computer system configurations including a personal computer (PC), a laptop computer, a handheld device, a multiprocessor system, microprocessor based or programmable consumer electronics, a network PC, a mini computer, a main frame computer, a mobile phone, a personal digital assistant (PDA), a pager, etc.

The present disclosure may also be executed in a distributed system environment in which both local and remote computer systems linked by a combination of a wired data link, a wireless data link, or a wired-and-wireless data link through a network perform a task.

In the distributed system environment, a program module may be disposed in local and remote memory storage devices.

Also, a party management service according to the present disclosure will be described using a data communication technology by means of wireless fidelity (Wi-Fi) and Bluetooth low energy (BLE). Various short-range communication technologies such as Wi-Fi, BLE, Bluetooth, Zigbee, ultra-wideband (UWB), antenna (ANT), and personal area network (PAN) are necessarily applicable to the party management service of the present disclosure.

A party management method and a device therefor according to an embodiment of the present disclosure will be described in detail hereinafter with reference to the drawings.

First, a basic structure of a party management system will be schematically described.

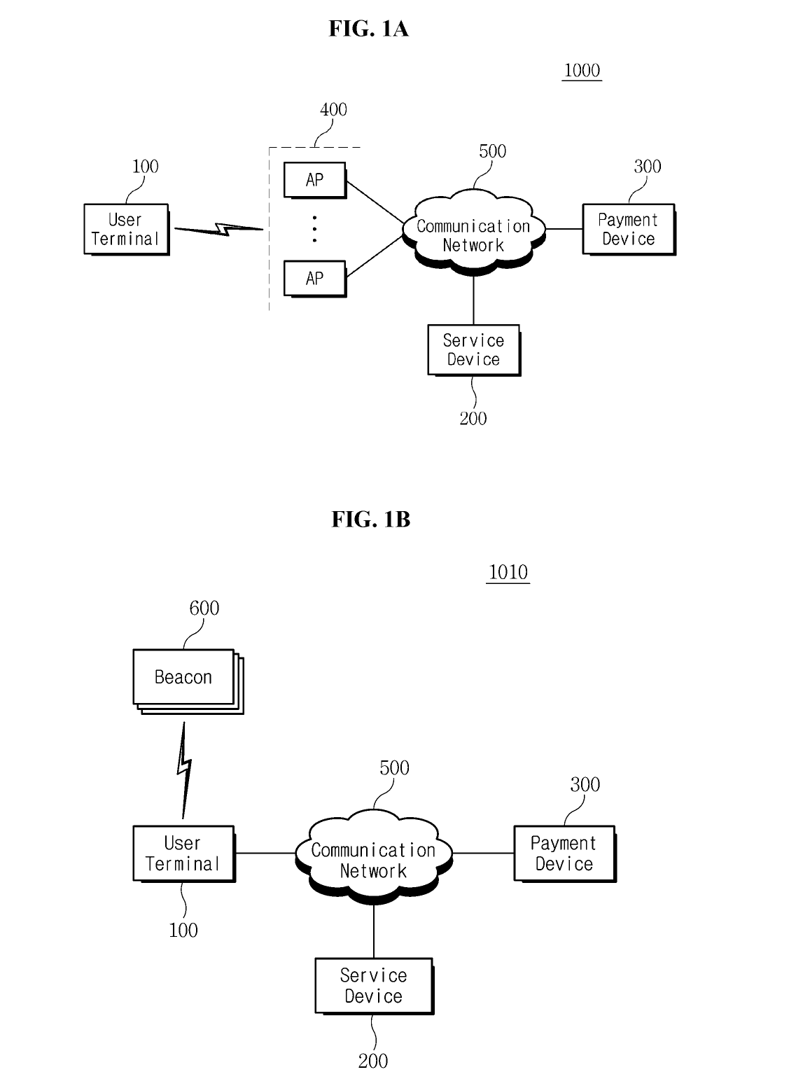

FIG. 1A is a view illustrating a schematic configuration of a general party management system.

Referring to FIG. 1A, a party management system 1000 may include a user terminal 100, a service device 200, a payment device 300, an access point (AP) 400, and a communication network 500.

Each of the elements will be briefly described. First, the user terminal 100 according to an embodiment of the present disclosure refers to a user device capable of transmitting and receiving various types of data via a communication network according to manipulation by a user.

The user terminal 100 according to an embodiment of the present disclosure is a terminal capable of short-range wireless communication and may receive a signal transmitted through a short-range wireless communication device including a Wi-Fi AP installed in a shop and, accordingly, may perform designated processing.

The user terminal 100 may perform voice or data communication through a communication network. For example, when the user terminal 100 receives a wireless AP signal transmitted from the AP 400, the user terminal 100 may communicate with the service device 200 through the communication network 500 and receive a service that manages a party by determining whether the user terminal 100 has entered or exited a shop according to information on the wireless AP signal received by the user terminal 100. For this, the user terminal 100 of the present disclosure may include a browser configured to transmit and receive information, a memory configured to store a program and a protocol, and a microprocessor configured to execute various types of programs and perform computing and control.

The user terminal 100 according to an embodiment of the present disclosure may be implemented in various forms. For example, mobile terminals, such as a smartphone, a tablet PC, and an MPEG-1 layer3 (MP3) player, as well as fixed terminals, such as a smart television (TV) and a desktop computer, may be used as the user terminal 100.

Due to convergence trends of digital devices, portable devices are transformed into a wide variety of devices, and it is impossible to enumerate all portable devices that may be the user terminal 100 of the present disclosure. However, units of an equivalent level as the units mentioned above may be used as the user terminal 100 according to the present disclosure. Any device capable of transmitting and receiving information to and from the service device 200 through the communication network 500 and receiving the wireless AP signal from the AP 400 may be applied as the user terminal 100.

Connection between the user terminal 100 according to the present disclosure and the AP 400 may be performed by short-range wireless communication including one of Wi-Fi and a mobile communication network.

The service device 200 according to an embodiment of the present disclosure may be connected to the user terminal 100 through the communication network 500.

The service device 200 may communicate with the user terminal 100, analyze wireless AP signal information received by the user terminal 100, determine whether the user terminal 100 has entered or exited a shop, determine a party as a result, and provide the user terminal 100 with content information related to a service.

Furthermore, the payment device 300 according to an embodiment of the present disclosure may receive a payment request from the user terminal 100 and make a payment or may directly make a payment request from a user corresponding to the user terminal 100.

In this way, the payment device 300 may provide the service device 200 with payment information generated according to a payment request.

The payment device 300 is a server operated by a payment institution such as a financial institution, a credit card company, or a mobile carrier that performs authentication and payment authorization tasks related to mobile payment. The payment device 300 performs a payment authorization task related to a payment request using the user terminal 100.

The AP 400 according to an embodiment of the present disclosure is a short-range wireless communication device installed in a shop to connect a wired local area network (LAN) to a wireless LAN (WLAN).

Also, the AP 400 according to an embodiment of the present disclosure may transmit a short-range wireless communication signal, e.g., a Wi-Fi signal.

When the user terminal 100 is a short distance from the AP 400, the user terminal 100 receiving a signal transmitted from the AP 400 shows a strong signal as signal intensity information. When the user terminal 100 according to an embodiment of the present disclosure approaches the AP 400, signal intensity information received by the user terminal 100 is transmitted to the service device 200 through the communication network 500. When the service device 200 determines that a signal intensity of the signal intensity information has increased to a critical value or higher, it may be determined that the user may has entered the shop.

Further, when the service device 200 determines that the signal intensity has decreased to lower than the critical value as a result of analyzing the signal intensity information received from the user terminal 100, it may be determined that the user has exited the shop.

Further, the user terminal 100, the service device 200, the payment device 300, and the AP 400 of the present disclosure are linked through the communication network and transmit and receive various pieces of information. Here, the communication network 500 may use a wireless communication means such as a wireless LAN (WLAN), Wi-Fi, wireless broadband (Wibro), Worldwide Interoperability for Micro-wave Access (Wimax), and high speed downlink packet access (HSDPA), but is not limited thereto, and may use a wired communication means such as Ethernet, X digital subscriber line (ADSL and VDSL), hybrid fiber coaxial (HFC) cable, fiber to the curb (FTTC), and fiber to the home (FTTH) according to a system implementation means.

Further, the communication network 500 of the present disclosure may include, for example, a plurality of connection networks (not illustrated) and a core network (not illustrated) and may include an external network, e.g., an Internet network (not illustrated). Here, the connection networks (not illustrated) are connection networks that perform wired and wireless communication with the user terminal 100 and may be implemented with a plurality of base stations such as a base station (BS), a base transceiver station (BTS), NodeB, and eNodeB and a base station controller such as a base station controller (BSC) and a radio network controller (RNC). Also, as described above, a digital signal processor and a wireless signal processor that are integrally implemented with the base stations may be differentiated as a digital unit (hereinafter, referred to as a DU) and a radio unit (hereinafter, referred to as an RU), a plurality of RUs (not illustrated) may be installed in a plurality of areas, and the plurality of RUs (not illustrated) may be connected to a centralized DU (not illustrated).

Also, the core network (not illustrated) that configures a mobile network with the connection networks (not illustrated) serves to connect the connection networks (not illustrated) to an external network, e.g., the Internet network (not illustrated).

As described above, the core network (not illustrated) is a network system that performs a main function for mobile communication service such as mobility control and switching between the connection networks (not illustrated). The core network (not illustrated) performs circuit switching or packet switching and manages and controls packet flow within the mobile network. Also, the core network (not illustrated) may manage mobility between frequencies and may serve to link the connection networks (not illustrated), traffic within the core network (not illustrated), and another network, e.g., the Internet network (not illustrated). The core network (not illustrated) may further include a serving gateway (SGW), a public data network (PDN) gateway, a mobile switching center (MSC), a home location register (HLR), a mobile mobility entity (MME), and a home subscriber server (HSS).

Also, the Internet network (not illustrated) signifies a general open communication network, i.e., a public network, through which information is exchanged according to transmission control protocol/Internet protocol (TCP/IP). The Internet network (not illustrated) may be connected to the service device 200, may provide information provided from the service device 200 to the user terminal 100 via the core network (not illustrated) and the communication networks (not illustrated), and may provide information provided from the user terminal 100 to the service device 200 via the communication networks (not illustrated) and the core network (not illustrated).

Also, other than the communication means described above, embodiments of the present disclosure may include other well-known communication means or all forms of communication means that will be developed in the future.

Hereinafter, a party management service system according to another embodiment of the present disclosure will be described.

Referring to FIG. 1B, a party management service system 1010 according to another embodiment of the present disclosure may include the user terminal 100, the service device 200, the payment device 300, the communication network 500, and a beacon 600.

The user terminal 100 according to the present disclosure may receive a beacon signal transmitted from a beacon device installed in a shop and provide information on the received beacon signal to the service device 200 via the communication network 500.

The beacon 600 according to another embodiment of the present disclosure is generally installed in a shop and transmits a beacon signal within a predetermined radius ranging from 5 cm to 49 m. The user terminal 100 that continuously scans whether a beacon signal transmitted within the predetermined radius is present may sense the beacon signal.

Also, the beacon 600 according to another embodiment of the present disclosure may operate based on an operational condition set by a beacon management server (not illustrated) and may transmit the beacon signal using short-range wireless communication.

The beacon 600 may transmit the beacon signal using BLE, but embodiments are not limited thereto. The beacon 600 may also transmit the beacon signal using radio frequency identification (RFID), Zigbee, NFC, and the like.

The beacon signal transmitted from the beacon 600 according to an embodiment of the present disclosure contains identification information for identifying the beacon 600. The identification information contained in the beacon signal may include one or more of a major that represents a universally unique identifier (UUID) of the beacon 600 and a group of beacon devices and a minor for identifying a particular beacon device within the group of beacon devices.

Also, the user terminal 100 according to an embodiment of the present disclosure may provide beacon signal information received from the beacon 600 to the service device 200, and the service device 200 may determine whether the user corresponding to the user terminal 100 has entered or exited a shop based on the provided information.

A processor embedded in each of the devices according to an embodiment of the present disclosure may process a program command for executing a method according to the present disclosure.

In one embodiment, the processor may be a single-threaded processor. In another embodiment, the processor may be a multithreaded processor.

Further, the processor may also process a command stored in a memory or a storage device.

Also, an example in which the beacon 600 and the user terminal 100 of the present disclosure transmit and receive information according to a BLE communication means has been described, but embodiments are not necessarily limited thereto. Any communication means capable of transmitting a certain signal that contains its own identification information is applicable to the present disclosure.

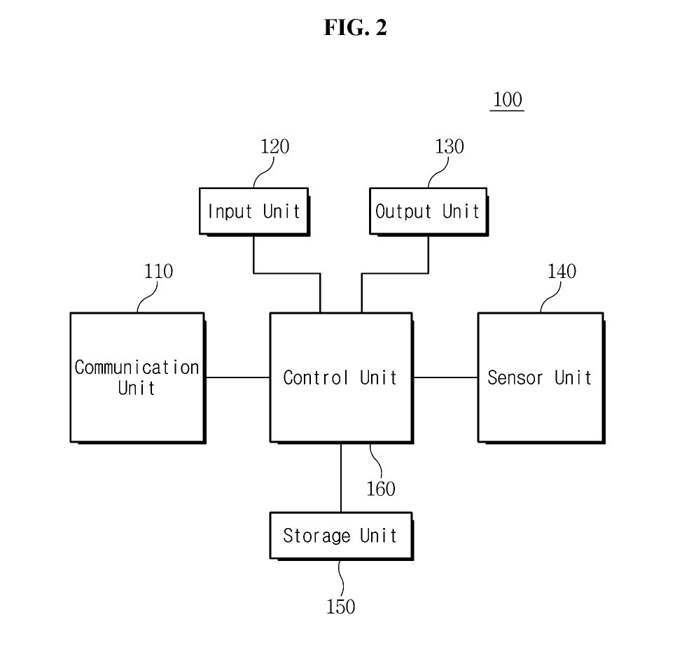

A process of a party management service according to an embodiment of the present disclosure described above will be described in more detail with reference to FIGS. 2 to 9.

Hereinafter, main configurations of the user terminal according to an embodiment of the present disclosure will be described.

FIG. 2 is a view illustrating main configurations of the user terminal 100 according to an embodiment of the present disclosure.

Referring to FIG. 2, the user terminal 100 according to an embodiment of the present disclosure is a device capable of communicating through the communication network 500 and being used by a user. For example, the user terminal 100 may be a smartphone and a tablet PC as well as various types of terminal devices capable of being connected to the wired or wireless Internet.

The user terminal 100 according to an embodiment of the present disclosure may include a communication unit 110, an input unit 120, an output unit 130, a sensor unit 140, a storage unit 150, and a control unit 160.

Each of the elements will be described in more detail. The communication unit 110 is a configuration for transmitting and receiving data through the communication network 500. Particularly, in the present disclosure, the communication unit 110 transmits and receives data related to a party management service to and from the service device 200 and the payment device 300 through the communication network 500.

The input unit 120 is a configuration for delivering various pieces of information such as information on numbers and letters input by the user and input signals related to various types of functional settings and functional control of the user terminal 100 to the control unit 160. The input unit 120 may include a gesture input means that includes one or more of a key input means such as a keyboard and a keypad, a touch input means such as a touch sensor and a touch pad, a voice input means, and a camera. Moreover, the input unit 120 may include any input means that is currently being developed or may be developed in the future.

The output unit 130 is a configuration for providing information on a series of operational states that occur while performing a function of the user terminal 100 and operational results in a form that is recognizable by the user. In the present disclosure, the output unit 130 may visually display various pieces of information generated while the party management service is being executed. For example, the output unit 130 displays a shop entered/exited state of the user, received signal intensity information, and information related to a payment.

The output unit 130 may be implemented in the form of a touch panel (or a touchscreen) with the input unit 120 as described above. When implemented with the input unit 120, the output unit 130 may display operations preset by the user, e.g., various pieces of information generated according to touch operations.

Also, the output unit 130 may be configured with a liquid crystal display (LCD), a thin film transistor LCD (TFT-LCD), organic light emitting diodes (OLEDs), LEDs, active matrix OLEDs (AMOLEDs), a flexible display, and a 3-dimensional display. Also, some of the displays may be configured to be transparent or have light transmitted therethrough so that the outside is visible through the displays. The displays may be configured in the form of a transparent display including a transparent OLED (TOLED).

The sensor unit 140 may sense a change in physical movement of the user terminal 100 and may include a gyro sensor, a geomagnetic sensor, an acceleration sensor, a proximity sensor, and a means capable of sensing information on various types of movement of the user terminal 100.

The storage unit 150 is a configuration for storing various data generated during execution of a program including an operating system (OS) program and an application program. Particularly, in the present disclosure, the storage unit 150 may store a party management program that is programmed to perform the party management service according to the present disclosure and may also store messages transmitted and received according to execution of a messenger program.

The storage unit 150 may be implemented using various types of storage media such as a flash memory, a hard disk, a multimedia card micro type memory (e.g., a secure digital (SD) or extreme digital (XD) memory) a RAM, and a ROM.

Lastly, the control unit 160 is a configuration for controlling an overall operation of the user terminal 100 and may be implemented using a processor, an OS program operated by the processor, and one or more application programs.

Next, the service device 200 according to an embodiment of the present disclosure will be described.

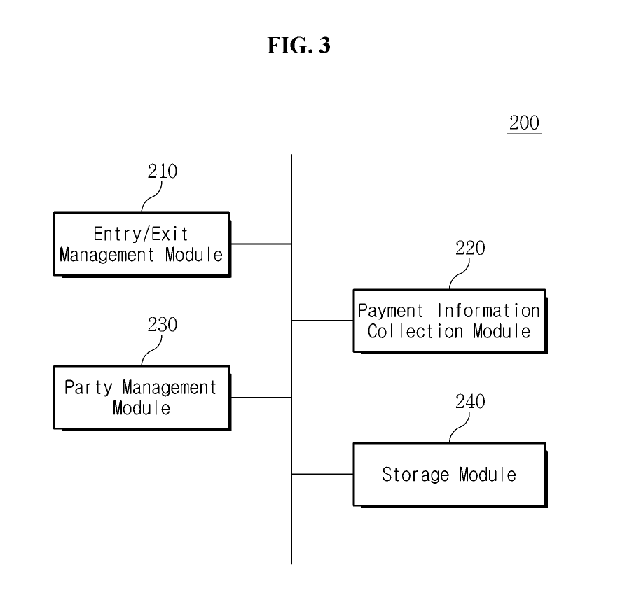

FIG. 3 is a view illustrating main configurations of the service device according to an embodiment of the present disclosure.

Referring to FIG. 3, the service device 200 according to an embodiment of the present disclosure may include an entry/exit management module 210, a payment information collection module 220, a party management module 230, and a storage module 240.

In the description below, each “module” is an element that performs a predetermined function and may be implemented by hardware, software, or a combination of hardware and software. For example, a “module” may signify a program module.

A “module” includes elements such as software elements, object-oriented software elements, class elements, and task elements, processes, functions, attributes, procedures, subroutines, program code segments, drivers, data, databases, data structures, tables, arrays, and variables. Also, elements and functions provided within “−modules” may be combined as a smaller number of elements and “−modules” or may be subdivided into additional elements and “−modules.”

A main configuration of the service device 200 of the present disclosure will be described in more detail. First, when the entry/exit management module 210 according to an embodiment of the present disclosure receives signal intensity information from the user terminal 100 that received a signal transmitted from a short-range wireless communication device installed in a shop, the entry/exit management module 210 of the service device 200 may determine whether a user corresponding to the user terminal 100 has entered or exited the shop based on the signal intensity information.

Here, when the signal intensity information received from the user terminal 100 has increased to a predetermined critical value or higher, the entry/exit management module 210 of the service device 200 may recognize that the user terminal 100 has approached the short-range wireless communication device installed in the shop and passed an obstacle such as a wall of the shop and determine that the user corresponding to the user terminal 100 has entered the shop.

On the other hand, when the signal intensity information received from the user terminal 100 has decreased to lower than the predetermined critical value, the entry/exit management module 210 of the service device 200 may recognize that the user terminal 100 has receded from the short-range wireless communication device installed in the shop and passed the obstacle such as the wall of the shop and determine that the user corresponding to the user terminal 100 has exited the shop.

That is, the entry/exit management module 210 of the service device 200 according to an embodiment of the present disclosure analyzes the signal intensity information received from the user terminal 100 and performs a function of determining whether the user corresponding to the user terminal 100 has entered or exited the shop according to whether the signal intensity is increased or decreased.

Further, the payment information collection module 220 of the service device 200 according to an embodiment of the present disclosure may receive payment information of the user terminal 100 from the payment device 300. Here, the payment information of the user terminal 100 received from the payment device 300 may include one or more of a payment time, a payment amount, information on a shop in which a payment is made, a unique identification number of a user terminal that has requested the payment, and information on a user who has requested the payment.

The party management module 230 of the service device 200 according to an embodiment of the present disclosure may generate user groups by time slot for multiple users that the entry/exit management module determined as having entered the shop.

Also, when a payment is made by any one of the users who have entered the shop, the party management module 230 of the service device 200 according to an embodiment of the present disclosure may set a first time range based on a time point at which the user who made the payment is confirmed as having exited the shop by the entry/exit management module 210 and determine that users confirmed to have exited the shop within the first time range are in the same party as the user who made the payment.

That is, users who exited the shop at a time point close to that at which the user who made the payment exited the shop may be determined to have exited the shop together with the user who made the payment.

Further, the party management module 230 of the service device 200 according to an embodiment of the present disclosure may select party) candidates before determining the same party. By selecting party candidates, the party management module 230 may more accurately perform the determination of the same party.

The selection of party candidates is performed by the party management module 230 of the service device 200. The selection of party candidates may include the sensor unit 140 included in the user terminal 100 acquiring movement information of multiple users who are included in a user group to which the user who made the payment belongs.

That is, the party management module 230 of the service device 200 according to an embodiment of the present disclosure may acquire movement information from the user terminal 100 and select users corresponding to user terminals from which movement of certain degree or more is detected for a predetermined amount of time as party candidates.

Also, the party management module 230 of the service device 200 according to an embodiment of the present disclosure may receive payment information from the payment device 300, select users corresponding to user terminals from which the movement of certain degree or more is detected for the predetermined amount of time based on a time point at which a payment is made as party candidates, and confirm whether the users included in the party candidates exit the shop to determine the same party.

Also, the party management module 230 of the service device 200 according to an embodiment of the present disclosure may assign a weight that is in consideration of a previous result of a determination stored in the storage module to the users in the user group to which the user who made the payment belongs and may perform the determination according to the weight.

That is, when multiple users enter or exit the shop in the same time slot, the users may be determined as a single user group or determined as being in the same party, and accuracy in determining the same party may be decreased. To prevent this, a weight may be assigned and users may be determined as being in the same party when there has been a case in which the users have been determined as being in the same party in consideration of a previous result of a determination with reference to pre-stored party information. In this way, even when different parties simultaneously enter or exit the shop, the pre-stored party information may be taken into consideration and determining the same party may be more accurately performed.

Also, the party management module 230 of the service device 200 according to an embodiment of the present disclosure may set the first time range based on a time point at which the user who made the payment exits the shop, determine users in a user group who exit within the first time range as being in the same party as the user who made the payment, assign a weight that is in consideration of a previous result of a determination stored in the storage module 240 to a user who exited the shop at a time point that deviates from the first time range among users in a user group to which the user who has made the payment belongs, and may determine a party according to the weight.

That is, a previous result of a determination is taken into consideration so that a user who exits the shop before or after the first time range but does not exit the shop together with the same party is determined as being in the same party. In this way, the user in the same party is not determined as being in a different party due to exiting the shop at a time point that deviates from the first time range.

Further, the party management module 230 of the service device 200 according to an embodiment of the present disclosure may remove a user who is determined to be in in the same party from the generated user group.

That is, a user determined to be in the same party may be removed from information on users who belong to the user group because a determination may be made related to a user who belongs to the user group but has not existed the shop yet.

Also, in the service device 200 according to an embodiment of the present disclosure, the storage module 240 may store a result of a determination of the same party by the party management module 230, and the party management module 230 may perform a determination of the same party in consideration of the result of the determination stored in the storage module 240.

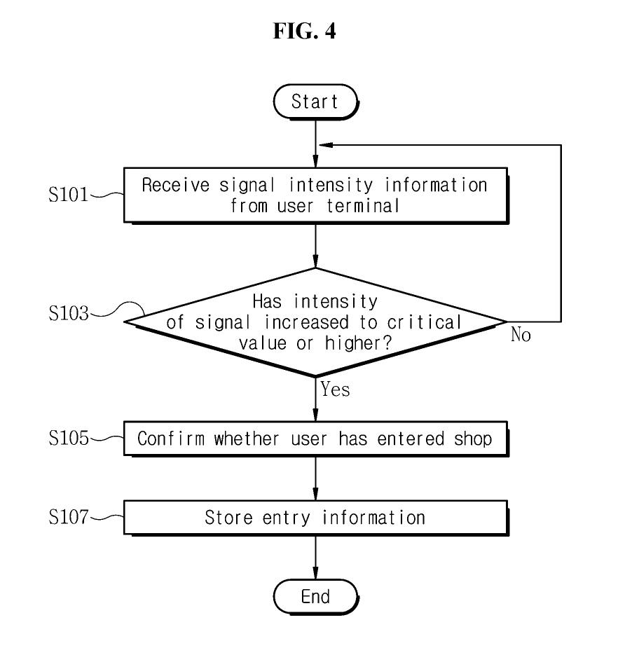

Specific operations of the service device 200 according to an embodiment of the present disclosure may be more clearly understood by flowcharts in FIGS. 4 to 6.

FIG. 4 is a flowchart illustrating a method of determining whether a user enters a shop by the service device according to an embodiment of the present disclosure.

Referring to FIG. 4, the service device 200 according to an embodiment of the present disclosure receives signal intensity information on a short-range wireless communication signal that is received by the user terminal 100 in a shop from the user terminal 100 (S101).

The service device 200 according to an embodiment of the present disclosure may determine whether a user has entered the shop based on the signal intensity information. For this, the service device 200 determines whether the intensity of the signal received by the user terminal 100 has increased to a critical value or higher (S103).

That is, when the user approaches the shop and enters the shop by passing an obstacle such as an entrance door or a wall of the shop, the user terminal 100 may receive a signal transmitted from a short-range wireless communication device installed in the shop and provide intensity information on the signal to the service device 200, and the service device 200 may analyze the signal intensity information and determine whether the intensity of the signal has increased to the critical value or higher to determine whether the user has entered the shop.

When a result of the determination shows that the intensity of the signal has increased to the critical value or higher, the service device 200 determines that a user corresponding to the user terminal 100 has entered the shop (S105) and stores entry information in the storage module (S107). Here, the entry information may include one or more of shop information, an entrance time, user information, and the number of visits of the user.

Meanwhile, when the result of determining whether the intensity of the signal has increased to the critical value or higher (S103) shows that the intensity of the signal has not increased to the critical value or higher, the user cannot be determined as having entered the shop, and a process of receiving the signal intensity information from the user terminal may be repeated.

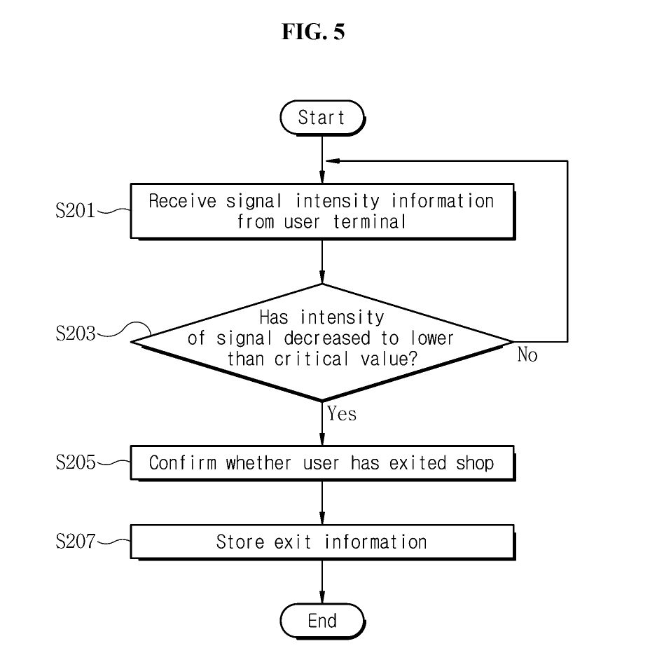

FIG. 5 is a flowchart illustrating a method of determining whether a user has exited the shop by the service device according to an embodiment of the present disclosure.

Referring to FIG. 5, the service device 200 according to an embodiment of the present disclosure receives signal intensity information on a short-range wireless communication signal that is received by the user terminal 100 in a shop from the user terminal 100 (S201).

The service device 200 according to an embodiment of the present disclosure may determine whether a user has exited the shop based on the signal intensity information. For this, the service device 200 determines whether the intensity of the signal received by the user terminal 100 has decreased to lower than the critical value (S203).

That is, when the user recedes from the shop and exits the shop by passing an obstacle such as an entrance door or a wall of the shop, the user terminal 100 may receive a signal transmitted from a short-range wireless communication device installed in the shop and provide intensity information on the signal to the service device 200, and the service device 200 may analyze the signal intensity information and determine whether the intensity of the signal has decreased to lower than the critical value to determine whether the user has exited the shop.

When a result of the determination shows that the intensity of the signal has decreased to lower then the critical value, the service device 200 determines that the user corresponding to the user terminal 100 has exited the shop (S205) and stores the exit information in the storage module (S207). Here, the exit information may include one or more of shop information, an exit time, user information, and the number of visits of the user.

Meanwhile, when the result of determining whether the intensity of the signal is decreased to lower than the critical value (S203) shows that the intensity of the signal has not decreased to lower than the critical value, the user cannot be determined as having exited the shop, and a process of receiving the signal intensity information from the user terminal may be repeated.

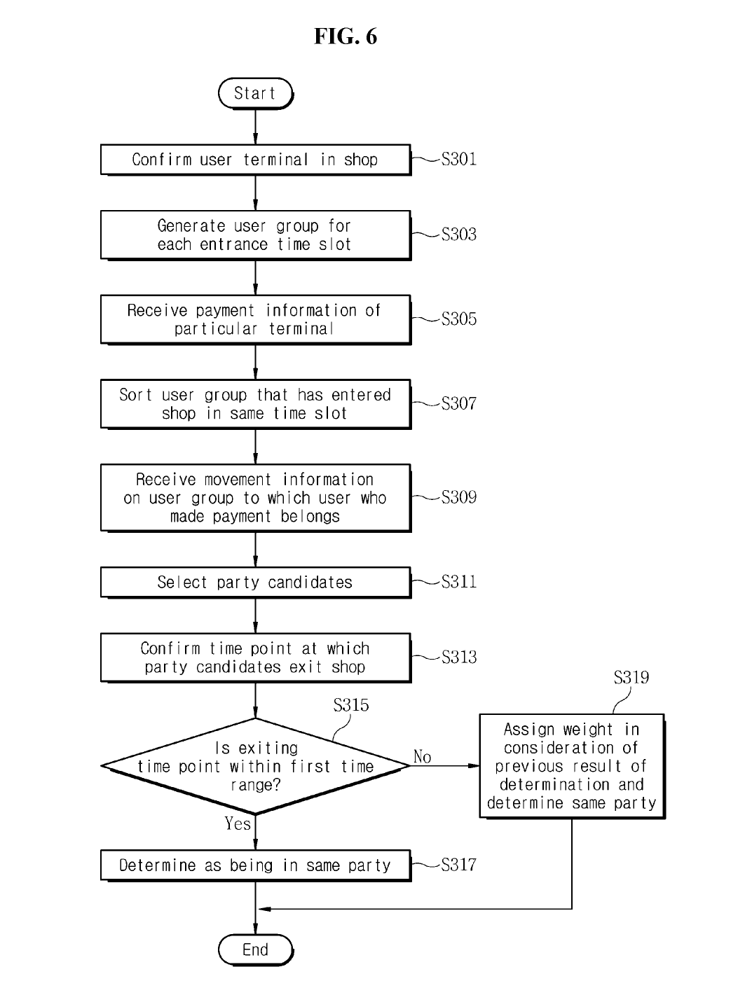

FIG. 6 is a flowchart for describing a party management service method by the service device according to an embodiment of the present disclosure.

Referring to FIG. 6, the party management module 230 of the service device 200 according to an embodiment of the present disclosure checks the user terminal 100 that is determined to have entered the shop (S301).

Then, a user group is generated by entrance time slot with reference to entry information stored when users entered the shop (S303) so that users who entered the shop together may be classified by group. Then, the service device 200 may receive payment information of a particular terminal from the payment device 300 (S305), sort a user group that entered the shop in the same time slot as a user who made a payment by referring to payment information (S307), and receive movement information from the user terminals 100 corresponding to multiple users in the user group to which the user who made the payment belongs (S309).

Then, the service device 200 may analyze the movement information received from the user terminal 100 and set user terminals from which movement of certain degree or more is detected within a predetermined amount of time as party candidates (S311). For example, when the service device 200 receives large degree movement information, e.g., several people simultaneously standing up to exit a shop such as a general restaurant, from the user terminals 100, the service device 200 may select the user terminals 100 as party candidates.

Then, the service device 200 may confirm a time point at which the users selected as party candidates exit the shop (S313), set a first time range based on a time point at which a user who made a payment exits the shop, determine whether the time point at which the party candidates exit the shop belongs to the first time range (S315), and determine that party candidates whose exiting time points belong to the first time range are in the same party (S317). Then, the service device 200 may store party information on users determined to be in the same party) in the storage module 240.

Meanwhile, when a result of the determining of whether the time point at which the party candidates exit the shop belongs to the first time range (S315) shows that the time point at which the party candidates exit the shop deviates from the first time range, a weight may be assigned in consideration of a previous result of a determination stored in the storage module 240, and the same party may be determined (S319).

That is, the same party is determined with respect to a user of a user group who has not exited together with others in the user group with reference to the previous result of the determination.

Hereinafter, a process in which the entry/exit management module 210 of the service device 200 according to an embodiment of the present disclosure determines whether users corresponding to the user terminals 100 have entered or exited a shop will be described with reference to the drawings.

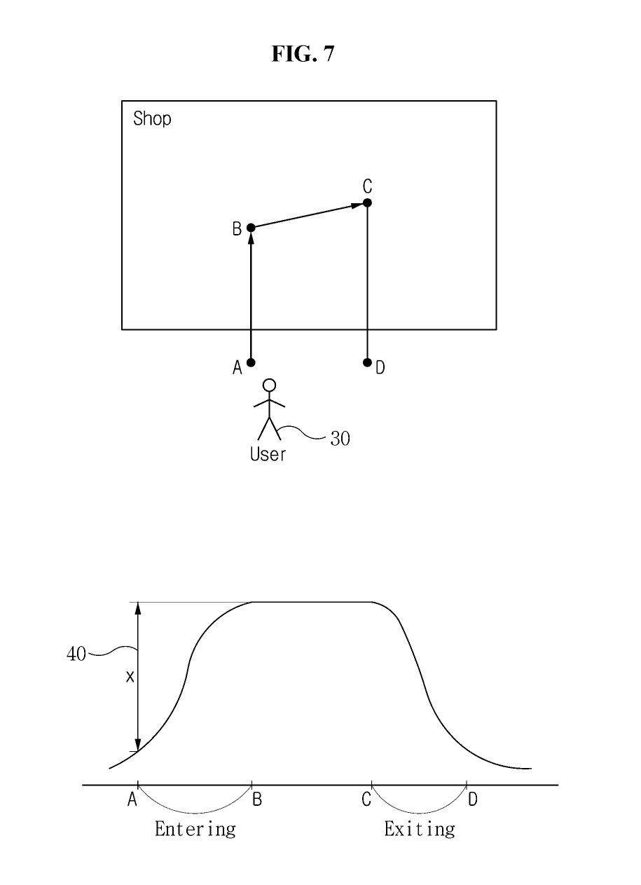

FIG. 7 is a flowchart for describing an initialization process in a beacon device according to an embodiment of the present disclosure.

Referring to FIG. 7, a signal intensity graph according to points A, B, C, and D, a shop, a user 30, and positions of the user are given. Here, the user 30 refers to a user who uses a party management service.

First, when the user 30 is at the point A, the user 30 may be recognized as being outside the shop and having a signal intensity value corresponding to the position.

Then, when the user 30 has moved to the point B, the user 30 may be determined as having entered the shop. Here, an intensity of a signal received from a short-range wireless communication device (not illustrated) installed in the shop may be increased by x (40) compared to the signal intensity at the point A.

When the user 30 moves to the point C and stays in the shop with users in the same party, the signal intensity value on the graph remains similar to that at the point B. Then, when the user 30 exits the shop, the user 30 moves to the point D. Here, it can be seen from the graph that the signal intensity value sharply decreases again.

In the party management service method according to an embodiment of the present disclosure, the signal intensity value may be increased by x (40) when the user enters the shop (A→B), and the service device 200 may confirm that the user has entered the shop when the value of x (40) is larger than a predetermined critical value to determine whether the user has entered or exited the shop.

Also, the signal intensity value may be decreased by x (40) when the user exits the shop (C→D), and the service device 200 may confirm that the user has exited the shop when the value of x (40) is smaller than the predetermined critical value.

That is, an A-B section of the graph may be described as a section in which the user enters the shop, and a C-D section may be described as a section in which the user exits the shop.

Hereinafter, a view for describing a method of determining the same party will be described to improve understanding of the party management service method according to an embodiment of the present disclosure.

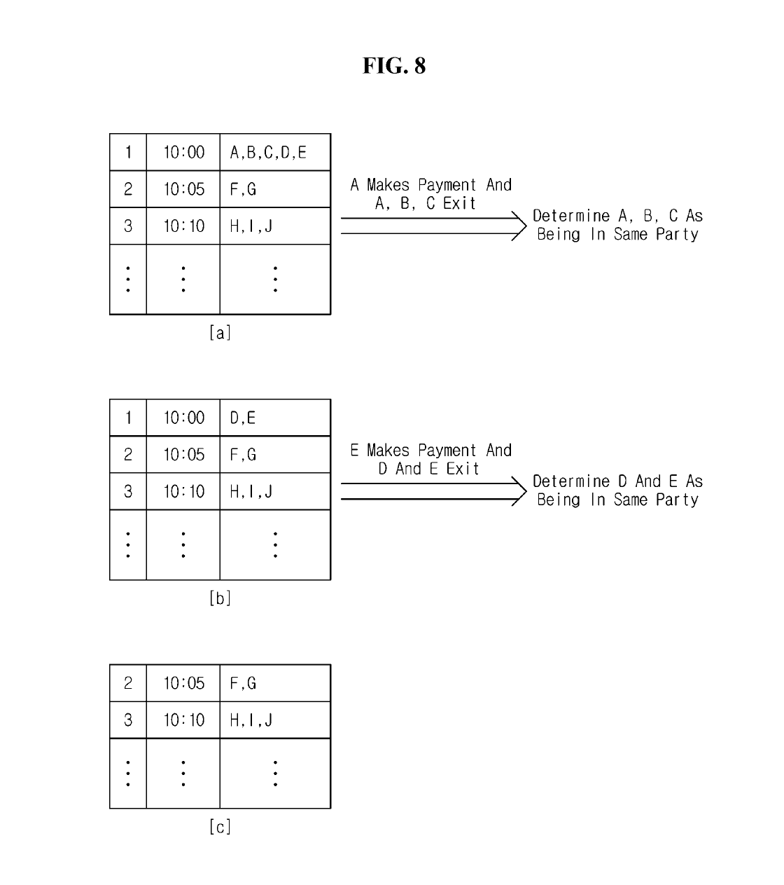

FIG. 8 is a view for describing a method of determining the same party according to an embodiment of the present disclosure.

A method of determining the same party and managing the party by going through processes [a], [b], and [c] will be described with reference to FIG. 8.

First, in Step [a], A, B, C, D, and E who entered the shop at 10:00 are designated as User group 1, F and G who entered the shop at 10:05 are designated as User group 2, and H, I, and J who entered the shop at 10:10 are designated as User group 3. Descriptions thereof will be given.

Also, although user groups are formed at five-minute intervals in this embodiment, time intervals may be set differently.

In Step [a], User group 1 consists of A, B, C, D, and E who entered the shop at 10:00. In User group 1, when A makes a payment and A, B, and C exit the shop within a predetermined first time range based on a time point at which the payment is made, the service device 200 according to an embodiment of the present disclosure may determine that A, B, and C are in the same party.

That is, A, B, C, D, and E may be determined to be in different parties according to a payer and exiting time points despite having entered the shop together and being determined to be in the same user group.

Next, in Step [b], A, B, and C who are previously determined as being in the same party are excluded from user group information. D and E who remain in User group 1 exit the shop, and E is a payer at this time. That is, D and E who have exited the shop within a first time range with respect to the time point at which E has made a payment may be determined as being in the same party.

Then, a state in which the rest of the user group information from which D and E are excluded is managed in a database may be viewed in [c]. The previous process [a]→[b]→[c] is repeatedly performed.

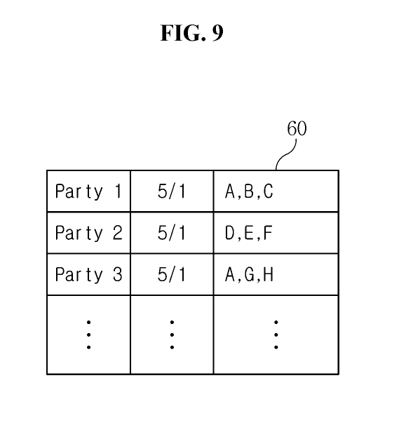

FIG. 9 is a view illustrating stored party information according to an embodiment of the present disclosure.

Referring to FIG. 9, party information 60 that contains personal information of parties as well as previously determined information on parties is stored.

According to an embodiment of the present disclosure, one or more of a party number, a party visit date, and party information may be managed.

Referring to FIG. 9, Party 1 visited the shop on May 1^{st} and includes A, B, and C as party information. Party 2 visited the shop on May 1^{st} and includes D, E, and F as party information. Party 3 visited the shop on May 1^{st} and includes A, G, and H as party information.

Here, User A belongs to both Party 1 and Party 3.

That is, it may be determined that User A visited the shop twice together with Party 1 and Party 3 and in different time slot. Consequently, the party information may further include a visit date and a visit time.

Referring to FIG. 9, when a party consisting of A, B, C, D, E, and H subsequently enters the shop in the same time slot, the service device 200 determines that A, B, C, D, E, and H are in the same user group. Here, A, B, C, D, E, and H are in the same user group but are not determined to be in the same party yet.

Then, whether the users in the user group are in the same party is determined. A payment is made by one of A, B, C, D, E, and H. A weight may be assigned to the users in the user group to which the user who has made the payment belongs in consideration of a previous result of a determination stored in the storage module, and the determination may be performed according to the weight.

For example, when A, B, C, D, E, and H enter the shop and form a single user group and a payment is subsequently made by B or C, a weight may be assigned to a determination of whether A, B, and C are in the same party in the user group to which B or C belongs in consideration of a previous result of determination (Party 1: A, B, C). Also, when A made the payment, a weight may be assigned to information in which A, B, C are determined as being in the same party and information in which A and H are determined as being in the same party in consideration of previously determined pieces of information (Party 1: A, B, C; Party 3: A, G, H), and the same party may be determined.

Also, when a payment is made by any one of D and E, a weight may be assigned to information in which D and E are determined as being in the same party with reference to previously determined information (Party 2: D, E, F), and whether the users are in the same party) may be determined.

Also, when H has made a payment, a weight may be assigned to information in which A and H are determined as being in the same party in consideration of previously determined information (Party 3: A, G, H), and whether the users are in the same party may be determined.

As described above, a weight is assigned in consideration of a previous result of a determination to determine the same party. In this way, possibility of erroneously determining users in different parties as being in the same party may be reduced at a time of determining the same party when different parties entered the shop in the same time slot.

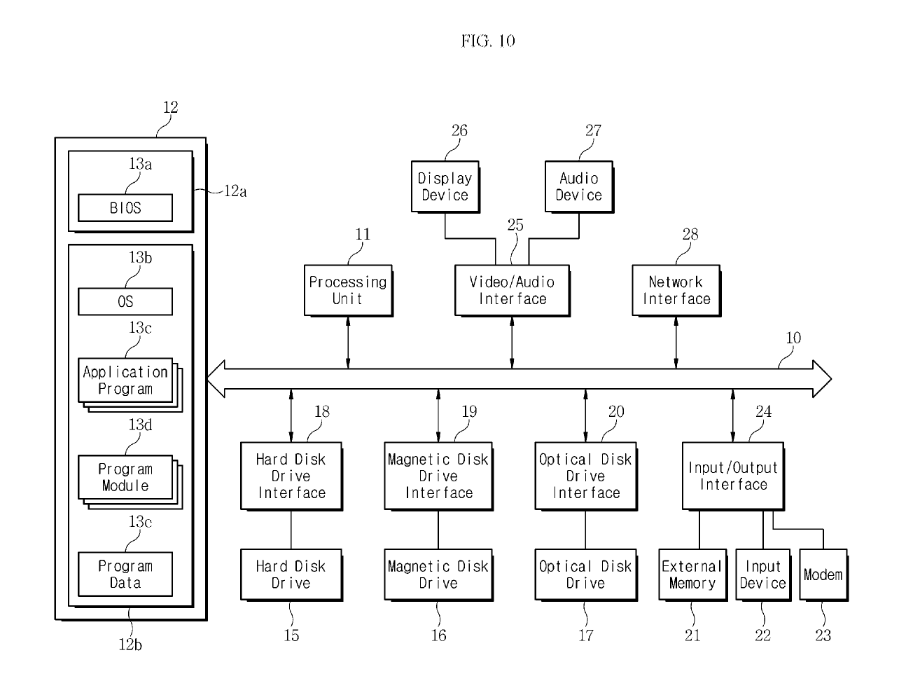

FIG. 10 is a view illustrating an operating environment of a device for providing a party management service according to an embodiment of the present disclosure.

FIG. 10 and the description below are intended to provide a simple and general description of a proper computing environment in which the present disclosure may be implemented.

Although not a requirement, the present disclosure may be described in relation to a computer executable command such as a program module executed by a computer system.

Generally, a program module includes a routine, a program, an object, a component, a data structure, and the like that perform a specific task, or implements a specific abstract data type.

A computer executable command, a data structure related thereto, and a program module show examples of a program coding means that executes actions of the present disclosure disclosed herein.

Referring to FIG. 10, an illustrative computing system that implements the present disclosure includes a computing device that is in a form which includes a processing unit 11, a system memory 12, and a system bus 10 configured to connect various system components including the system memory 12 to the processing unit 11.

The processing unit 11 may execute a computer executable command designed to implement a feature of the present disclosure.

The system bus 10 may be any one of a few types of bus structures including a local bus, a peripheral bus, a memory bus, and a memory controller that use any of a variety of bus architectures. The system memory 12 includes a ROM 12a and a RAM 12b.

A basic input/output system (BIOS) 13a that includes a basic routine that assists in transmitting information between elements within the computing system at a certain time, such as during operation, may be generally stored in the ROM 12a.

The computing system may include a storage means, e.g., a hard disk drive 15 configured to read out information from a hard disk or record information to the hard disk, a magnetic disk drive 16 configured to read out information from a magnetic disk or record information to the magnetic disk, and an optical disk drive 17 configured to read out information from an optical disk, such as a CD-ROM and other optical media, and record information to the optical disk.

The hard disk drive 15, the magnetic disk drive 16, and the optical disk drive 17 are respectively connected to the system bus 10 by a hard disk drive interface 18, a magnetic disk drive interface 19, and an optical disk drive interface 20.

Also, the computing system may further include an external memory 21 as a storage means. The external memory 21 may be connected to the system bus 10 via an input/output interface 24.

The drives described above and related computer readable media from and to which information is read out and recorded by the drives provide nonvolatile storage of a computer executable command, a data structure, a program module, and other data. Although the hard disk drive 15, the magnetic disk drive 16, and the optical disk drive 17 are described herein as illustrative computing environments, other types of computer readable media, including a magnetic cassette, a flash memory card, a digital versatile disk (DVD), a Bernoulli cartridge, a RAM, a ROM, and the like, configured to store data may be used.

Program coding means such as an OS 13b, one or more application programs 13c, other program modules 13d, and one or more program modules including the program data 13e may be stored in the hard disk drive 15, the magnetic disk drive 16, the optical disk drive 17, the ROM 12a, or the RAM 12b.

Further, the computing system may receive a command and information from a user via other input devices 22 such as a keyboard, a pointer, a microphone, a joystick, a game pad, a scanner, and the like.

The input devices 22 may be connected to the processing unit 11 via the input/output interface 24 connected to the system bus 10.

The input/output interface 24 may logically show any of a wide variety of different interfaces such as a serial port interface, a personal system (PS)/2 interface, a parallel port interface, a universal serial bus (USB) interface, and an institute of electrical and electronics engineers (IEEE) 1394 interface (i.e., a FireWire interface) or logically show a combination of different interfaces.

In addition, the computing system to which the present disclosure is applied may further include a display device 26 such as a monitor or an LCD or an audio device 27 such as a speaker or a microphone. The display device 26 and the audio device 27 are connected to the system bus 10 via a video/audio interface 25.

For example, other peripheral output devices (not illustrated) such as a speaker and a printer may also be connected to a computer system 420.

The video/audio interface 25 may include a high definition multimedia interface (HDMI), a graphics device interface (GDI), and the like.

Also, the computing system that executes the present disclosure may be connected to a network such as an office-broadband or company-broadband computer network, a home network, an intranet, and/or the Internet.

The computer system may exchange data with external sources such as a remote computer system, a remote application, and/or a remote database via the above networks.

For this, the computing system to which the present disclosure is applied includes a network interface 28 configured to receive data from an external source and/or transmit data to the external source.

In the present disclosure, the computing system may transmit and receive information to and from a device at a remote place through the network interface 28.

The network interface 28 may be shown as a logical combination of one or more software and/or hardware modules such as a network interface card and a corresponding network driver interface specification (NDIS).

Likewise, the computer system receives data from an external source or transmits data to the external source via the input/output interface 24.

The input/output interface 24 may be connected to a modem 23 (e.g., a standard modem, a cable modem, or a DSL modem) and may receive data from the external source and/or transmit data to the external source via the modem 23.

FIG. 10 illustrates an operating environment appropriate to the present disclosure. However, a principle of the present disclosure may be employed in any system capable of implementing the principle of the present disclosure by being properly modified when necessary.

The environment illustrated in FIG. 10 is merely illustrative and does not illustrate even a small part of a wide variety of environments in which the principle of the present disclosure may be implemented.

Further, various pieces of information generated when a party management service program of the present disclosure is executed may be stored in any computer readable medium related to the computing system in FIG. 10 and accessed.

For example, some of program modules and some of program data related thereto may be included in the OS 13b, the application programs 13c, the program modules 13d, and/or program data 13e to be stored in the system memory 12.

Also, when a mass storage device such as a hard disk is connected to the computing system, program modules and program data related thereto may be stored in the mass storage device.

In a network environment, program modules related to the present disclosure or some of the program modules may be stored in a remote computer system connected thereto via the modem 23 of the input/output interface 24 or the network interface 28, e.g., in a remote memory storage device such as a system memory and/or a mass storage device related to a computing system of the user terminal 100, the service device 200, and the payment device 300.

Execution of the modules may be performed in a distributed environment as described above.

As described above, this specification includes details of a plurality of specific implementations. However, the details are not to be understood as limiting any of the scope of the disclosure or claims but should rather be understood as describing features that particular embodiments of particular disclosure may have.

Particular features described herein in the context of separate embodiments may be implemented in combination in a single embodiment.

Conversely, various features described in the context of a single embodiment may be implemented separately or in any proper lower-level combinations in a plurality of embodiments. Further, features may be claimed as operating in particular combinations and may be described as claimed as above at an early stage. However, one or more features may be excluded from the claimed combinations in some cases, and the claimed combinations may be changed to lower-level combinations or modifications of the lower-level combinations.

Likewise, although operations are illustrated in the drawings in specific orders, it should be understood that the operations do not have to be performed in the illustrated specific orders or sequential orders or that all of the illustrated operations do not have to be performed to obtain a preferred result.

In a particular case, multitasking and parallel processing may be advantageous. Also, detachment of various system components in the embodiments described above should be understood as not being required in all of the embodiments, and it should be understood that the program components and the systems described herein may be integrated with a single software product or packaged to multi-software products.

Particular embodiments of a subject described in this specification have been described. Other embodiments belong to the scope of the claims below.

For example, operations cited in the claims may still achieve a preferred result even by being performed in a different order.

In one example, the processes illustrated in the accompanying drawings are not necessarily required to be performed in the illustrated specific orders or sequential orders to obtain a preferred result. In a specific embodiment, multitasking and parallel processing may be advantageous.

The description herein proposes the best mode of the present disclosure and provides an example for enabling one of ordinary skill in the art to manufacture and use the preset disclosure to describe the present disclosure.

The specification written in this way does not limit the present disclosure by specific terms proposed herein.

Consequently, although the present disclosure has been described in detail with reference to the embodiments described above, one of ordinary skill in the art may alter, change, and modify the embodiments without departing from the scope of the present disclosure.

Consequently, the scope of the present disclosure should be defined by the claims below instead of the embodiments described herein.

Meanwhile, the embodiments of the present disclosure disclosed in this specification and the drawings are merely specific examples for assisting in understanding the present disclosure and are not intended to limit the scope of the present disclosure.

It should be obvious to those of ordinary skill in the art to which the present disclosure pertains that modified embodiments based on the technical spirit of the present disclosure other than the embodiments disclosed herein may be practiced.

The present disclosure relates to a party management service method and a device therefor. Whether users have entered or exited a shop can be determined through signal intensity information from a user terminal that received a short-range wireless communication signal transmitted from a short-range wireless communication device installed in the shop, and whether the users are in the same party can be determined.

In this way, shop visit information of users who have visited a shop but have not made a payment may be acquired in addition to that of a user who has made a payment. Because shop visit records of the users can be identified, it may be a great help in analyzing consumers for marketing.

Also, the users who have visited a shop but have not made a payment may be provided with pieces of content that fit their shop visit records. Because the users can easily acquire information on products in which they are interested, it may be helpful to sales.

This can contribute to developing the service industry. In addition, the present disclosure is industrially applicable due to having sufficient marketability or commercial value and practically and clearly being able to be practiced.

What is claimed is:

1. A service device comprising:
an entry/exit management module configured to receive signal intensity information on a short-range wireless communication signal received by a user terminal from the user terminal and determine whether a user has entered or exited a shop based on the signal intensity information:
a payment information collection module configured to receive payment information of the user terminal from a payment device; and
a party management module configured to generate user groups by time slot for multiple users determined as having entered the shop by the entry/exit management module and, when a payment is made by any one of the users who entered the shop, determine that users, that are confirmed as having exited the shop within a first time range based on a time point at which the user who made the payment is confirmed as having exited the shop, among users in a user group to which the user who made the payment belongs are in the same party as the user who made the payment.

2. The service device of claim 1, further comprising a storage module configured to store a result of the determination by the party management module.

3. The service device of claim 1, wherein the entry/exit management module determines that the user has entered the shop when intensity of the short-range wireless communication signal from the user terminal has increased to a critical value or higher and determines that the user has exited the shop when the intensity of the short-range wireless communication signal has decreased to lower than the critical value.

4. The service device of claim 1, wherein, before determining the same party, the party management module acquires movement information from a plurality of user terminals included in the user group to which the user who made the payment belongs, selects users corresponding to user terminals from which movement of certain degree or more is detected for a predetermined amount of time as party candidates, and confirms whether the users included in the party candidates have exited the store.

5. The service device of claim 1, wherein the party management module assigns a weight to the users in the user group to which the user who made the payment belongs in consideration of a previous result of a determination stored in a storage module, and performs the determination according to the weight.

6. The service device of claim 1, wherein the party management module assigns a weight to a user who exited the shop at a time point that deviates from the first time range among the users in the user group to which the user who made the payment belongs in consideration of a previous result of determination stored in a storage module, and determines the same party according to the weight.

7. The service device of claim 1, wherein the party management module removes a user who is determined as being in the same party from the generated user group.

8. A party management service method comprising:
receiving, by a service device, intensity information on a short-range wireless communication signal from a user terminal;
determining, by the service device, whether a user has entered or exited a shop based on the received signal intensity information;
generating, by the service device, user groups by time slot for multiple users determined as having entered the shop;
receiving, by the service device, payment information of the user terminal from a payment device; and
when a payment is made by any one of the users who entered the shop, determining, by the service device, that users, that are confirmed as having exited the shop within a first time range based on a time point at which the user who made the payment is confirmed as having exited the shop, among users in a user group to which the user who made the payment belongs are in the same party as the user who made the payment.

9. The party management service method of claim 8, further comprising, after the determining the same party, storing a result of the determination by the party management module.

10. The party management service method of claim 8, wherein the determining of whether the user has entered or exited the shop includes determining that the user has entered the shop when intensity of the short-range wireless communication signal from the user terminal has increased to a critical value or higher and determining that the user has exited the shop when the intensity of the short-range wireless communication signal has decreased to lower than the critical value.

11. The party management service method of claim 8, comprising:
before the determining the same party, acquiring movement information from a plurality of user terminals included in the user group to which the user who made the payment belongs:
selecting users corresponding to user terminals from which movement of certain degree or more is detected for a predetermined amount of time as party candidates; and
confirming whether the users included in the party candidates have exited the store.

12. The party management service method of claim 8, wherein the determining the same party includes assigning a weight to the users in the user group to which the user who has made payment belongs in consideration of a previous result of a determination stored in a storage module, and performing the determination according to the weight.

13. The party management service method of claim 8, wherein the determining the same party includes assigning a weight to a user who exited the shop at a time point that deviates from the first time range among the users in the user group to which the user who made the payment belongs in consideration of a previous result of a determination stored in a storage module, and determining the same party according to the weight.

14. The party management service method of claim 8, further comprising, after the determining the same party, removing a user who is determined as being in the same party from the generated user group.
